(19) United States
(12) Patent Application Publication
(10) Pub. No.: US 2007/0062267 A1
(43) Pub. Date: Mar. 22, 2007

(54) Preheater plug comprising a pressure sensor and engine fitted therewith

(76) Inventors: Michel Boucard, Tournefeuille (FR); Bernd Last, Reutlingen (DE); Cyrille Patri, Toulouse (FR); Alain Ramond, Merville (FR); John Burrows, Cheshire (GB); Sandro Goretti, Rubiera (IT)

Correspondence Address: YOUNG & THOMPSON, 745 SOUTH 23RD STREET, 2ND FLOOR, ARLINGTON, VA, 22202, US

(21) Appl. No.: 10/577,151

(22) PCT Filed: Oct. 28, 2004
(86) PCT No.: PCT/FR04/02783

§ 371 Date: Sep. 1, 2006

(30) Foreign Application Priority Data
Oct. 29, 2003 (FR) 0312682

(51) Int. Cl. G01L 3/26

(52) U.S. Cl. 73/115

(57) ABSTRACT

The preheater plug (1) includes a tubular body inside which a pressure sensor (90) is mounted, the pressure sensor measuring the internal pressure of an engine cylinder wherein the plug (1) is arranged. The pressure sensor is provided with connection lugs extending in a substantially longitudinal manner in relation to the axis of the tubular body. The body (10) has a lateral groove in the inner lateral wall. At least one connection lug is engaged in the groove.

The present invention concerns a glow plug comprising a pressure sensor making it possible to measure the pressure of an engine cylinder in which the glow plug is accommodated.

A glow plug is known comprising a pressure sensor adapted to measure the internal pressure of an engine cylinder in which the glow plug is accommodated, a body adapted to be fixed to the engine and a finger in which a pre-heating electrode is accommodated.

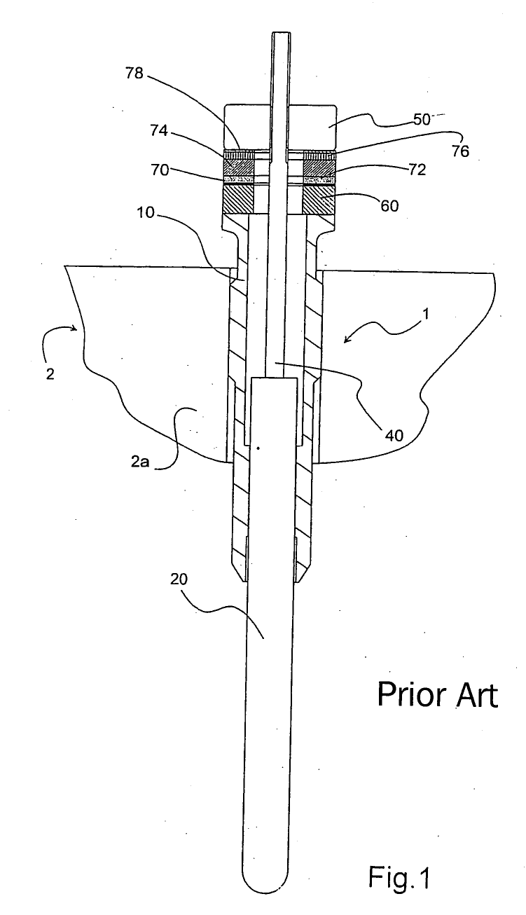

As can be seen in FIG. 1 (which illustrates a section view of a glow plug of the prior art), in order to be able to measure the pressure in the cylinder without making any major modification to the structure of the glow plug, the sensor is disposed between the body on which it bears, and a nut connected to the upper end of a core which transmits the electrical energy to the pre-heating electrode and which extends the finger in the body and beyond by passing through the sensor.

The pressure within the cylinder is felt by the finger of the glow plug and the variations in pressure undergone by the finger are transmitted to the sensor through the core which is connected thereto.

In such a glow plug, contrary to what is represented in FIG. 1, the pressure sensor is usually accommodated within the body of the glow plug and bears on a shoulder formed in that tubular body. In this manner, the sensor is thus protected from external aggressions. The outer surface of the body, adjacent to the pressure sensor, itself has a cylindrical form of hexagonal cross-section. This portion of the body is then used for the screwing of the glow plug into the engine. The portion of the glow plug then remaining outside the engine is generally termed glow plug head.

The dimensions of the glow plug head are determined in relation to the space available in the engine in the vicinity thereof. Most commonly, that space is limited. On account of this, the size of the pressure sensor is also limited. However, to improve the sensitivity of a pressure measurement, it is preferable to have a sensor presenting the greatest possible bearing surface.

An object of the present invention is thus to create a glow plug comprising a pressure sensor in which the latter may have a bearing surface that is as great as possible according to the size of the glow plug head.

To that end it provides a glow plug comprising a tubular body within which is mounted a pressure sensor adapted in particular to measure the internal pressure of a cylinder of an engine in which the glow plug is accommodated, the pressure sensor being provided with connecting tabs extending substantially longitudinally with respect to the axis of the tubular body According to the invention, the body has on its inner sidewall a longitudinal groove into which fits at least one connecting tab.

In this way the housing in which the pressure sensor locates may be entirely used for the sensor itself without having to leave space for the means enabling the electrical connection of the sensor. It is thus possible to optimize the size of the sensor fitting into the glow plug.

To facilitate the mounting of the various members composing the pressure sensor, the groove advantageously pierces through, so forming a longitudinal slot in the tubular body. In this case, when the body has, adjacent to the pressure sensor, an outer cylindrical surface of hexagonal cross-section thereby forming a surface with six facets, the slot opens preferably entirely in one facet of the outer surface of the body in order not to weaken the latter too much. However, since the couples applied during the screwing or unscrewing of a glow plug in a cylinder head are not very great, it is nevertheless possible to provide for the width of the slot to correspond to the width of a facet of the body.

In a glow plug according to the invention, the sensor is for example a piezoelectric sensor comprising a piezoelectric member arranged between two contact members. In this embodiment, the connecting tabs each advantageously form only a single part of bent form together with a contact member of the sensor. This makes it possible to limit the bulkiness of the sensor.

The present invention also concerns a glow plug body comprising a substantially circular cylindrical tubular portion at the end of which there is a gripping zone with six facets, of hexagonal cross-section, characterized in that the gripping zone has a longitudinal slot. Such a glow plug body corresponds to a glow plug as described above. This glow plug body may be such that the longitudinal slot extends across the entire width of a facet of the gripping zone.

Finally, the invention also concerns an internal combustion engine comprising at least one cylinder and at least one glow plug, characterized in that the glow plug is a glow plug as described above.

Other features and advantages will appear in the description of the embodiment given by way of non-limiting example and illustrated by the accompanying drawings in which:

FIG. 1 represents a cross-section of a glow plug of the prior art;

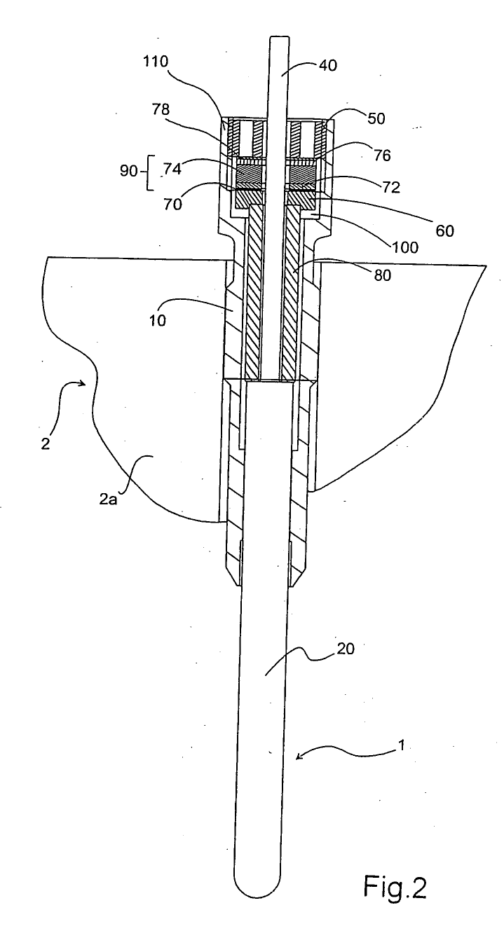

FIG. 2 represents a view similar to FIG. 1 of a glow plug in accordance with the present invention;

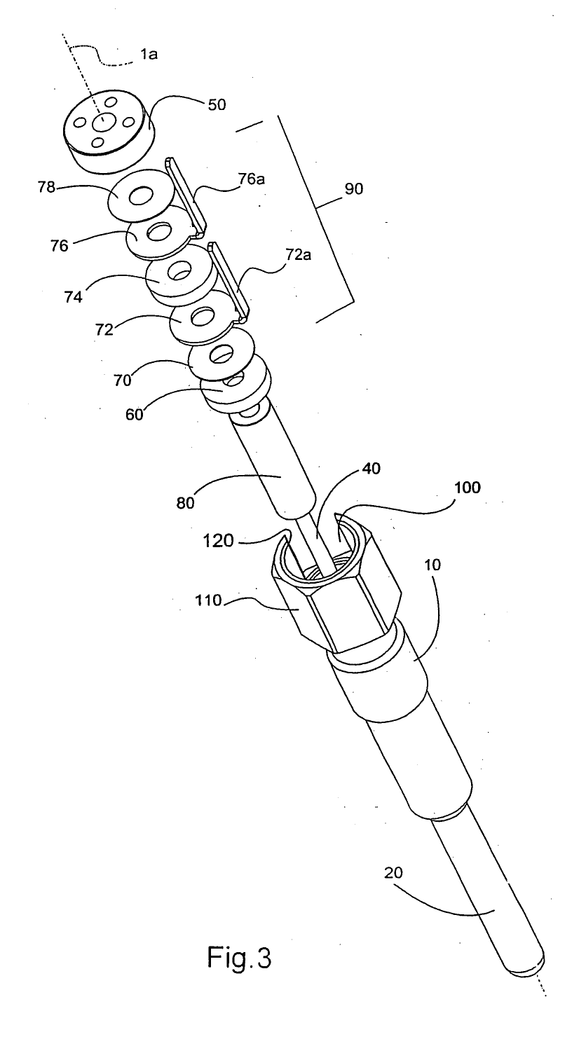

FIG. 3 is an exploded perspective view of the glow plug illustrated in FIG. 2; and

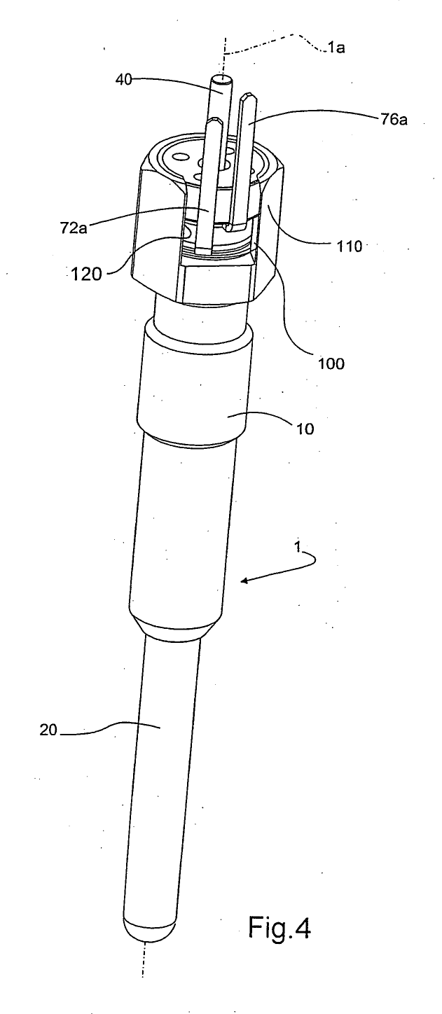

FIG. 4 is a perspective view of the glow plug illustrated in FIGS. 2 and 3.

As can be seen in FIGS. 2, 3 and 4, a glow plug 1, here for an internal combustion engine 2 (typically a Diesel engine having a cylinder head 2a) comprises a body 10, a finger 20, a core 40 and a pressure sensor 90.

In a conventional manner, the body 10 is adapted to be fixed to the engine 2, for example by screwing to the cylinder head 2a. The finger 20, within which is accommodated a pre-heating electrode of the glow plug 1, is disposed in the body 10 and is attached thereto by crimping. The core 40 transmits the electrical energy to the electrode situated in the finger 20 and is thereby in contact with that electrode and is connected to the finger 20 which it extends within the body 10, and beyond (its free end, enabling its electrical connection to an electrical conductor for supply, projects out from the body 10).

The pressure sensor 90 is adapted to measure the internal pressure of the cylinder (or one of the cylinders) of the engine. In the present example, the sensor 90 comprises a piezoelectric member 74 arranged between two contact members 72,76 of electrically conductive material, and which is electrically insulated from the rest of the glow plug 1, in this case by two electrically insulating members 70,78. The members 72,76 each comprise a bent lateral electrical connection tab 72a, 76a directed towards the free end of the core 40 and extending substantially parallel to the longitudinal axis 1a of the glow plug (cf. FIGS. 3 and 4).

The sensor 90 is connected to the body 10 by its upper surface and bears against the finger 20, such that the pressure exerted on the finger 20 compresses it against the body 10.

It is clear that any compression of the finger 20 directly results in compression of the sensor 90 against the body 10. Thus, the sensor 90 no longer needs to be pre-stressed to measure the pressures existing in the engine.

As can be seen in FIG. 2, the core 40 passes through the sensor 90 but is not in contact with the latter. On account of this, the vibrations of the core 40 are not transmitted to the sensor 90. Thus the function of the core 40 is essentially only the transmission of the electrical current to the pre-heating electrode of the finger 20, as in the pre-heating electrodes without a pressure sensor.

In the present example, the sensor 90 bears on a spacer 80 which rests on the finger 20 and which is disposed in the body 10, without contact with the latter. Naturally, the spacer 80 which surrounds the core 40, is not in contact with it.

This spacer 80, without modifying the dimensions of the finger 20 and of the body 10, makes it possible to accommodate the sensor 90 in the upper portion of the glow plug 1, and not in the body 10 at the location of the upper end of the finger 20 which would give rise to supplementary stresses (obligation to use sensors of very small outer diameter having lower sensitivities and exposure to higher temperatures generated by the finger 20).

As can be seen in FIG. 2, the sensor 90 is disposed in a cavity 100 formed at the upper end of the body 10, known as the head of the body 10. This portion of the body 10 remains outside the engine when the glow plug is mounted therein. The term glow-plug head is also given to the whole portion of the that glow plug of greater outer diameter and which remains outside the engine.

The upper end of the spacer 80 projects beyond the bottom wall of the cavity 100 such that the sensor 90 does not rest on the body 10.

The location of the sensor 90 in the body 10 makes it easy to form an overmolding of plastics material of the upper portion of the glow plug 1, the overmolding making it possible to ensure the fluid-tightness and to perfect the electrical connection of electrical wires to the connectors of the sensor 90.

The spacer 80 is formed of a material giving it a good level of stiffness (given the dimensional constraints imposed by the inner diameter of the body 10, the outer diameter of the core 40 and the respective lengths of the body 10 and of the finger 20), and enabling it to have its own vibrational mode (markedly) beyond the bandwidth of the sensor 90 (thus, the spacer 80 is not itself subjected to vibrations liable to cause interference to the measurements made by the sensor 90).

Preferably, the spacer 80 is formed of ceramic, this material having the different properties desired (insulation, stiffness, vibrations beyond the bandwidth and good mechanical strength at high temperatures).

Furthermore, in the present example, a bearing piece 60 is interposed between the sensor 90 and the spacer 80 in order to distribute the pressure from the spacer 80 over the whole surface of the sensor 90.

The glow plug 1 also comprises a nut 50 disposed on the sensor 10, and of which the screwing onto the body 10 gives rise to the compression of the sensor 90 against the finger 20 (via the spacer 80 and the bearing piece 60) and its connection to the body 10.

The nut 50 which is connected to the body 10 and which, of course, is not in contact with the core 40 makes it possible to appreciably dampen the vibrations of the electrical connectors of the sensor 90, by compressing the sensor.

In the present example, the screw thread of the nut 50 is formed on its outer periphery and cooperates with an internal screw thread formed on the inner surface of the side walls 110 of the cavity 100.

It may be noted that the head of the body 10 has an outer surface with six facets. This head is thus of cylindrical form with a hexagonal cross-section.

In order to have a pressure sensor 90 with a piezoelectric member 74 as large as possible, a slot 120 is formed in one side wall 110. This slot 120 is of a width corresponding to the wall in which it is formed, such that the wall disappears. The head of the body 10 then in fact only has five side walls 110.

In this way, the lateral electrical connection tabs 72a, 76a may be accommodated in the slot 120 of the head of the body 10 without depriving the pressure sensor 90 of space within that head. More particularly, without that slot 120, space would need to be kept in cavity 100 for the passage of at least the lateral electrical connection tab 72a which corresponds to the contact member 72 located the furthest inwards of the glow plug. This passage would then be to the detriment of the size of the piezoelectric member 74 of the pressure sensor 90 of which the size would then have to be reduced and thus to the detriment of the sensitivity of the sensor.

Thus, forming the glow plug 1 according to the present embodiment is particularly simple: it is composed of a stack of parts; no severe pre-stress of the sensor 90 is necessary, it suffices to compress it lightly to prevent it from moving. Furthermore, since the core is no longer used to transmit the pressure variations to the sensor, it is possible to reduce its diameter and thus to use a sensor 90 having inner and outer diameters that are relatively small (for example an inner diameter of 2.6 millimeters and an outer diameter of 8.5 millimeters).

This glow plug 1 may also receive a sensor 90 which occupies the whole of the cavity 100 provided for that purpose in the head of the glow plug by virtue of the presence of the slot 120. This is favorable to the sensitivity of the sensor 90. The tightening couples usually used for screwing in a glow plug are such that the presence of the slot 120, even when it corresponds to the entire width of a facet of a head with six facets, does not alter the durability of the body 10 and there is no risk of deforming the head of the body on screwing in or unscrewing.

Of course, it is possible to modify the present embodiment.

For example, it is possible to have a slot in the head of the glow-plug, or of the body of the glow plug, without providing for connecting the sensor to the body of the glow plug by its upper face and to make it bear against the finger such that the pressure exerted on the finger compresses the sensor against the body of the glow plug. Such a slot can be envisaged with any glow plug structure incorporating a pressure sensor in its head. The slot may for example be envisaged with a pressure sensor mounted like the one of FIG. 1.

1-10. (canceled)

11. A glow plug (1) comprising a pressure sensor (90) adapted to measure the internal pressure of the cylinder of an engine in which the glow plug (1) is accommodated, a body (10) adapted to be fixed to the engine, and a finger (20) in which a pre-heating electrode is accommodated, characterized in that the sensor (90) is connected to the body (10) by its upper surface and bears against the finger (20) via of a spacer (80), such that the pressure exerted on the finger (20) compresses it against the body (10).

12. A glow plug (1) according to claim.11, characterized in that the spacer (80) is formed from a material of which its own vibration mode is beyond the bandwidth of the sensor (90).

13. A glow plug (1) according to claim 12, characterized in that the spacer (80) is of ceramic.

14. A glow plug (1) according to claim 11, characterized in that a nut (50) is screwed to the body (10) and compresses the sensor (90) so as to connect it to the body (10).

15. A glow plug (1) according to claim 14, characterized in that the screw thread of the nut (50) is formed on its outer periphery and cooperates with a screw thread formed on the inner surface of the side walls (110) of a cavity (100) in which the sensor (90) is accommodated.

16. A glow plug (1) according to claim 11, characterized in that the sensor (90) comprises a piezoelectric member (74) which is arranged between two contact members (72, 76) and is electrically insulated from the rest of the glow plug (1).

17. An internal combustion engine comprising at least one cylinder and one glow plug (1) according to claim 11, in which the pressure sensor (90) is adapted to measure the internal pressure of the cylinder in which the glow plug (1) is accommodated, and in which the body (10) is fixed to the engine.

18. A glow plug (1) according to claim 12, characterized in that a nut (50) is screwed to the body (10) and compresses the sensor (90) so as to connect it to the body (10).

19. A glow plug (1) according to claim 13, characterized in that a nut (50) is screwed to the body (10) and compresses the sensor (90) so as to connect it to the body (10).
